(19) United States
(12) Patent Application Publication
(10) Pub. No.: US 2016/0000273 A1
(43) Pub. Date: Jan. 7, 2016

(54) PERSONALISED SUSTAINABLE SHOWER APPARATUS HAVING A PLURALITY OF SHOWER HEADS

(71) Applicant: CONOPCO, INC., D/B/A UNILEVER, Englewood Cliffs, NJ (US)

(72) Inventors: Nimish Harshadrai SHAH, Bangalore (IN); Venkatesh SHANKAR, Bangalore (IN)

(73) Assignee: Conopco, Inc, d/b/a UNILEVER, Englewood Cliffs, NJ (US)

(21) Appl. No.: 14/442,139

(22) PCT Filed: Nov. 14, 2013
(86) PCT No.: PCT/EP2013/073837

§ 371 Date: May 12, 2015

(30) Foreign Application Priority Data
Nov. 21, 2012 (IN) 3333/MUM/2012
Jan. 3, 2013 (EP) 13150090.2

(51) Int. Cl. A47K 3/28; B05B 1/18; B05B 7/08

(52) U.S. Cl. CPC A47K 3/28; B05B 7/0853; B05B 1/185

(57) ABSTRACT

Disclosed is a sustainable shower apparatus (1) having: (i) a housing (2) for an object (3); and (ii) plurality of shower heads (4a, 4b, 5a, 5b, 6a, 6b, 7a, 7b) positioned at different heights for spraying a mist comprising a pressurised gas and a liquid on said object; wherein each shower head comprises at least one set of nozzles, where each set comprises: (a) a nozzle (22) for spraying said gas; and (b) adjacent thereto, at least one nozzle (20, 22) for spraying said liquid, and wherein in each said set, the tip of each nozzle for spraying said liquid is at an acute angle to the tip of each adjacent nozzle for spraying gas.

### FIELD OF THE INVENTION

The invention relates to sustainable shower apparatus suited for community use.

### BACKGROUND OF THE INVENTION

Showers can be commonly found in houses, hotels, hostels, aircrafts, traveller's lounges, community showering facilities centres and several other places. Although, not so common, showers are also used for bathing animals, generally pets. They are also used to clean inanimate objects like cars. Showers supply constant flow of slightly pressurised water for a perceivable degree of cleansing, particularly when aided with a cleansing agent. However, showers require a lot of water. Therefore, sustainable showers were introduced. These showers consume lesser water as air or any other gas is used to partly substitute the water.

Showers are also used in a community context. Such places include aircrafts, lounges and public bathing centres. At such places, in addition to sustainability and basic minimum cleansing, the users also expect a quick shower, usually a bath which gets over in two to three minutes. At the same time, users also desire some degree of personalisation, which includes features where the flow can be particularly directed to one or more specific parts of the body.

Known shower apparatus do not disclose such features.

US2003/0163867A1 (Ronghua Zhou) discloses a portable shower having a frame and plurality of spray nozzles for delivering water flow from multiple locations and in multiple directions into the shower stall. The limitations of the disclosed apparatus are twofold.

First, it is not a sustainable shower because it uses huge quantity of water. Second, the disclosed features do not allow for personalised cleansing.

A somewhat similar construction has been disclosed in U.S. Pat. No. 5,469,587B1 assigned to Fendall Corporation.

Our unpublished co-pending application EP 12 16 9017 discloses a sustainable shower apparatus having an enclosure, a frame and plurality of shower nozzles disposed on a movable ring which sweeps the users body. There are some nozzles for spraying water and some are for spraying pressurised gas. All the shower nozzles are disposed in the same plane. Each nozzle for spraying water is at an acute angle with an adjacent nozzle for spraying the gas. The apparatus is particularly suited for community use. A limitation of the apparatus is that it does not allow enough room for personalisation. A drawback of the apparatus is that it has a movable ring for which appropriate safety measures are necessary.

DE4325971C1 (KIRCHHOFF KLAUS) discloses an apparatus in which nozzles are adjustable by hand so that the output beam is variable in direction and can be adapted to the respective needs. There are multiple water spray nozzles, cleaning agent spray nozzles and air flow nozzles which spray water, cleansing agent and air one after the other.

U.S. Pat. No. 6,047,416B1 (Denis Carrier) discloses a shower device for 360° sweeping of the user's body. The water is sprayed from a shower head and a series of holes in tubes along the space provided for use as a shower stall. The holes are positioned to direct the sprays of water toward the centre of the shower stall. A rotary servomechanism induces circular movement of the tubes around the shower stall, and this movement combines with the water spray action from the tubes to provide coverage in the space at the centre of the shower stall.

EP2233649 A2 (CHAN CHESTA et. al., 2009,) discloses a shower system of exposed type comprising a main flow passage connected to a water supply; at least two conduits which are in communication with the main flow passage and connected in pair and horizontally to two sides of the main flow passage; at least two shower spray spouts in communication with the at least two conduits, and the shower spray spouts being carried at respective outer ends of the conduits; wherein the conduits are arranged such that the shower spray spouts are in a 180 degrees counter sit relationship with respect to the main flow passage and are combined with the conduits to define a shower stall.

US2005210576 AA (THE BOEING COMPANY) discloses an expandable, modular, multi-mode lavatory for aircraft featuring its multi-mode use as a lavatory, shower and accommodations for handicapped persons. It comprises a primary structure with a volume that expands into adjacently located unused space, such as an aircraft's main entry cross-aisleway. Deployable walls and doors are used to create a partitioned environment. A false bottom shower pan cover provides structural support for wheelchairs while also being removable to reveal a modular shower pan for bathing.

Thus, it can be seen that none of the cited documents discloses a shower apparatus which is sustainable, which provides a quick shower, which is simple in construction and which also allows for personalisation by the user.

Therefore, it is desirable to have a shower apparatus which is appropriately designed for a quick shower which provides good hydrodynamic cleansing when used especially in the community context. Desired also is an apparatus in which there is optimal use of gas and the liquid, particularly water, while at the same time providing 360° cleansing using a simple construction.

We have determined that at least some of the problems can be solved when the apparatus has plurality of shower heads positioned at different heights for spraying a mist of a pressurised gas and a liquid, in conjunction, on an object, and in which each shower head has nozzles for spraying a gas and a liquid where the nozzles are oriented in a particular manner. The shower heads are mounted on movable, e.g. pivot joints to enable movement which provides room for personalisation.

### SUMMARY OF THE INVENTION

In accordance with a first aspect is disclosed a sustainable shower apparatus having:
(i) a housing for an object; and
(ii) plurality of shower heads positioned at different heights for spraying a mist comprising a pressurised gas and a liquid on said object;
   wherein each shower head comprises at least one set of nozzles, where each set comprises:
   (a) a nozzle for spraying said gas; and
   (b) adjacent thereto, at least one nozzle for spraying said liquid, and wherein in each said set, the tip of each nozzle for spraying said liquid is at an acute angle to the tip of each adjacent nozzle for spraying gas.

### DETAILED DESCRIPTION OF THE INVENTION

In accordance with a first aspect is disclosed a sustainable shower apparatus having:
(i) a housing for an object; and
(ii) plurality of shower heads positioned at different heights for spraying a mist comprising a pressurised gas and a liquid on said object;
   wherein each shower head comprises at least one set of nozzles, where each set comprises:
   (a) a nozzle for spraying said gas; and
   (b) adjacent thereto, at least one nozzle for spraying said liquid, and wherein in each said set, the tip of each nozzle for spraying said liquid is at an acute angle to the tip of each adjacent nozzle for spraying gas.

The plurality of shower heads positioned at different heights allows for personalization and targeted delivery of the mist to various, but particular parts of the body. Each shower head is supported or carried by a pipe. The length of the pipe provides the desired height. The shower heads can be movable along the length of the pipe thereby allowing for adjusting height of the nozzles. However, in a preferred embodiment, the position of each said shower head is fixed at given height. Shower heads fixed at given heights will make the apparatus less complex and more user-friendly.

It is further preferred that each nozzle is placed at a height of from 20 to 180 cm. This arrangement will provide for full body coverage.

It is further preferred that the plurality of shower heads is made up of plurality of sets of shower heads where each set includes at least two shower heads disposed at substantially the same height and substantially opposite to each other.

Placement of the shower heads at substantially the same height and substantially opposite to each other provides 360° cleansing i.e. cleansing of all parts of the body. For example, when a shower head positioned at chest height cleanses the chest of the user, the other shower head disposed substantially at the same height but on the opposite side will cleanse the back of the user. In this manner, the user will not have to necessarily turn around while bathing.

It is particularly preferred that the shower apparatus has at least four sets of shower heads where each set has two shower heads. This feature allows for further optimization of the number of shower heads and thereby enhances simplicity of the apparatus as well as the sustainability factor.

In such a case, it is preferred that the first set of shower heads is positioned at height of 20 to 65 cm from base. These nozzles will cleanse the lower body. The second set of shower heads is preferably position at height of 40 to 105 cm from base. This will cleanse the hips and the opposite side of the body. The third set of shower heads is preferably positioned at height of 70 to 145 cm from base. This will cleanse the torso. Finally, the fourth set of shower heads is preferably positioned at height of 120 to 165 cm from base. These shower heads will primarily cleanse the face and the head.

It is further preferred that each said shower head is movable by at least 180° in vertical or horizontal direction or both. This feature will allow the user to further personalize the showers and to direct the mist to any particularly desired part or portion of the body. Shower heads can be made movable in any known manner. Non-limiting examples include the use of goose-neck fitting or a pivot joint.

The shower apparatus is defined by a frame which creates an enclosure for the person or the object. The shape, size and dimensions of the apparatus (defined by the frame) can be varied to suit the end application.

Accordingly, the shape of the apparatus can be any regular figure such as a square, rectangle or triangle or it can be any irregular figure. However, in a preferred apparatus, the plurality of shower heads are arranged along perimeter of a circle of diameter 45 to 150 cm, more preferably 45 to 105 cm and optimally from 60 to 75 cm.

In a further preferred embodiment, the plurality of shower heads are arranged along a major arc of the circle, more particularly wherein angle of the major arc is 245° to 320°. Such an arrangement provides further optimization of space as all the nozzles are properly positioned leaving adequate free or unobstructed space for entry/exit of the person and in which space; a door can be easily fitted. Further even when the nozzles are arranged along a major arc of the circle, as the nozzles are movable along horizontal or vertical direction, the user will still be able to get 360° cleansing. This feature makes the apparatus further user-friendly.

### Shower Head and Nozzles

In a preferred apparatus, each shower head has one set of nozzles. It is further preferred that each set has three nozzles having a middle nozzle for spraying the gas and two nozzles adjacent thereto, one each on either side thereof for spraying the liquid.

The nozzles can either be oriented horizontally or vertically.

In a highly preferred embodiment, in each set of nozzles, the tip of the nozzle for spraying the gas and the tips of the nozzles for spraying the liquid are not offset. However, it is equally preferred that the tip of the middle nozzle for spraying the gas terminates a distance of up to 0.4 cm before or up to 1 cm ahead of the tips of each nozzle for spraying liquid.

Outside the preferred range, there is a possibility of inadequate contact of the gas with the water which might affect the spray pattern.

It is further preferred that all nozzles in each set of nozzles are coplanar. Co-planarity allows the liquid and gas to be sprayed effectively and uniformly, while allowing the mist to be directed properly towards the object or user. Each spray head is supplied the gas and the liquid by an external source. The source of the liquid can be a reservoir and the source of the gas can be a suitable compressor. The pipe on which each shower head is supported is preferably supplied with the gas and the liquid through respective tubing. The tubing terminates into a respective nozzle in the shower head.

It is preferred that the disclosed acute angle is 20° to 60°. Preferred angles enable better cleansing and targeted delivery of the mist of the gas and water.

Angles lower than 20° are less preferred because the spray pattern and reach of the spray is adversely affected. In further preferred embodiments this acute angle is 40° to 50°. The optimal acute angle is 45°. In the case of angles greater than 60° the coverage is more but impact of the mist is lower. This may affect cleansing. At the same time, angles lower than 20° cause a greater impact, which could be found inconvenient by some users. Further, the coverage is lowered. In the case of angles greater than 60° the coverage is more but impact of the mist is lower. This affects the cleansing.

Preferably the internal diameter of each nozzle is 0.5 mm to 0.8 mm, more preferably from 0.6 mm to 0.7 mm. This provides proper balance between pressure, reach, coverage and cleansing efficacy. When the internal diameter is below 0.5 mm, the shower experience is not pleasurable as a proper mist will not be formed. On the other hand, diameters above 0.8 mm will lead to increased water consumption and create oversized droplets which are difficult to be conveyed by the gas under manageable pressure.

Internal diameter of the nozzles is also important from the point-of-view of safety as well as from the efficacy of cleaning. In the case of normal showers, a question of safety does not arise because the size of droplets is well within the prescribed limits of safety. However, in the case of gas-assisted showers, uncontrolled sizes can be harmful. Droplet sizes lower than 8 μm can adversely affect the respiratory system because finer droplets can enter the lungs. On the other hand, larger droplets do not pose such safety related problems but can adversely affect the sensorial perception and reduce the pleasure of showering. Oversized droplets have lower surface area. Therefore, there is lesser cleansing.

In a preferred sustainable shower apparatus, the liquid is water. When water turns into a mist, it cools rapidly, especially if the mist traverses a distance of more than ten inches (25.4 cm). This cooling effect can be used for a refreshingly cool bathing experience in the hot season. It is preferred that temperature of water is from 10° C. to 60° C. On the other hand, where people prefer hot or warm showers, the in-use temperature needs to be higher. In such cases, it is preferred that in-use temperature, particularly of water is in the range of 40° C. to 60° C. maintained by heating the water appropriately. If required, water can also contain small amount of a cleansing composition, such as a shower gel or a perfume or fragrant material. Solvents can be used to clean inanimate objects like cars. If desired, the water can be pressurised, but this is not essential as the flow through the nozzles will itself result in some pressure which is generally adequate.

A preferred gas is selected from air, oxygen or carbon dioxide. Any other suitable gas may be used subject to safety compliance for the intended application. In order to aid cleaning, the operating pressure of the gas is preferably maintained from 2 bar to 8 bar, more preferably 4 bar to 8 bar. There preferably is a final drying cycle in which hot or cold gas, preferably air, is sprayed. This feature can further enhance comfort, convenience and the sustainability factor, as towels need not necessarily be used.

The features are especially relevant in the context of community shower facilities where time, water and availability of shower facilities are limited.

It is preferred that the shower apparatus has a frame to support and cover the shower heads. The frame is a structure that provides fixed dimensions to the shower apparatus.

In order to have ample availability of the liquid whenever necessary, the shower apparatus also preferably has a storage compartment. This can be in the form of an overhead tank. Alternatively, there is a running supply of the liquid, as is common in the case of water.

It is preferred that flow rate of the liquid, particularly water, is maintained in the range of 100 to 300 ml/minute. In preferred embodiments, the rate is 100 to 250 ml/minute.

Preferred embodiments of the shower apparatus consume 1 litre to 4 litres of the liquid, particularly water, for one-time use, which more preferably is 1 to 2 litres. The shower apparatus provides a single complete shower experience with significantly limited amount of water as compared to conventional showers and known quick showers, or even a bucket bath which is practiced in many parts of the world. A typical quick conventional shower uses anywhere from 10 to 15 litres of water, whereas typical bucket bath needs about 20 litres water.

Known quick showers can provide up to 10 showers per hour. A preferred shower apparatus provides one shower in one to two minutes.

The disclosed shower apparatus provides one complete shower experience typically in about 2 minutes, including, as described earlier with appropriate program controls, a drying cycle. Therefore the disclosed apparatus is capable of providing about 25 to 30 showers per hour.

While the shower apparatus can be made without a platform or a cover, it is preferred that the housing has a roof and a platform for a comfortable enclosure for the user or the object. The platform is useful for positioning the object when the shower is in use.

Further, the platform has a raised pedestal for placing the object or on which a person can stand. This will provide additional comfort. The apparatus is preferably enclosed by a covering made of any suitable material such as glass, plastic, wood, ceramic, stainless steel, or shower drapes or curtains. Other equivalent materials include hard plastics, polymers, fibre glass or Teflon®. The frame, roof, platform, pipes and the nozzles are preferably made of stainless steel but any other material of construction can be used.

In order to drain away the used water, it is preferred that the shower apparatus includes an outlet. This is preferably placed on or near the platform. Used water can be recycled to further enhance the sustainability factor. In order to increase the sustainability factor, the shower apparatus has a means for post-use treatment to enable reuse or recycle. For this purpose, the shower apparatus has, at the base of the apparatus, or any convenient location, a provision for collection of waste water. An appropriate provision can be made for transferring this water to a suitable storage or treatment plant to treat the water to make it fit for other applications (e.g. gardening/agriculture).

Known devices and compositions which are fit for this purpose can be used. Such device(s) can be suitably placed outside or inside the apparatus.

In order to make the shower apparatus comfortable for human beings, it is preferred that an exhaust fan is included in the housing. It can be located at any suitable position, such as near the roof.

After completion of one shower, the apparatus is preferably sanitized by any known means, such as fumigation to make it hygienic and ready-to-use for the next user. Appropriate electronically controlled timed-release means can be used for this purpose. Such means (dispensers) are commonly found in public bathrooms, where a device sprays a perfume at pre-determined timed intervals.

The shower apparatus is primarily meant for the purpose of community bathing and disclosed preferred embodiments are designed for this purpose. Accordingly, the shower apparatus is primarily meant for human beings, but with appropriate modifications, it can be made fit for use for pets or other animals or any other inanimate object, such as a car. The dimensions of the shower apparatus can be designed according to the purpose for which it is being used.

The invention will now be explained in more details with the help of exemplary non-limiting embodiments.

### BRIEF DESCRIPTION OF THE FIGURES

FIG. 1 is an isometric view of a preferred embodiment of a shower apparatus.

FIG. 2 is isometric view of the embodiment of FIG. 1 showing a user adjusting the shower heads.

FIG. 3 is top (plan) view of a shower head.

FIG. 4 is side view of the shower head shown in FIG. 3.

### DETAILED DESCRIPTION OF THE FIGURES

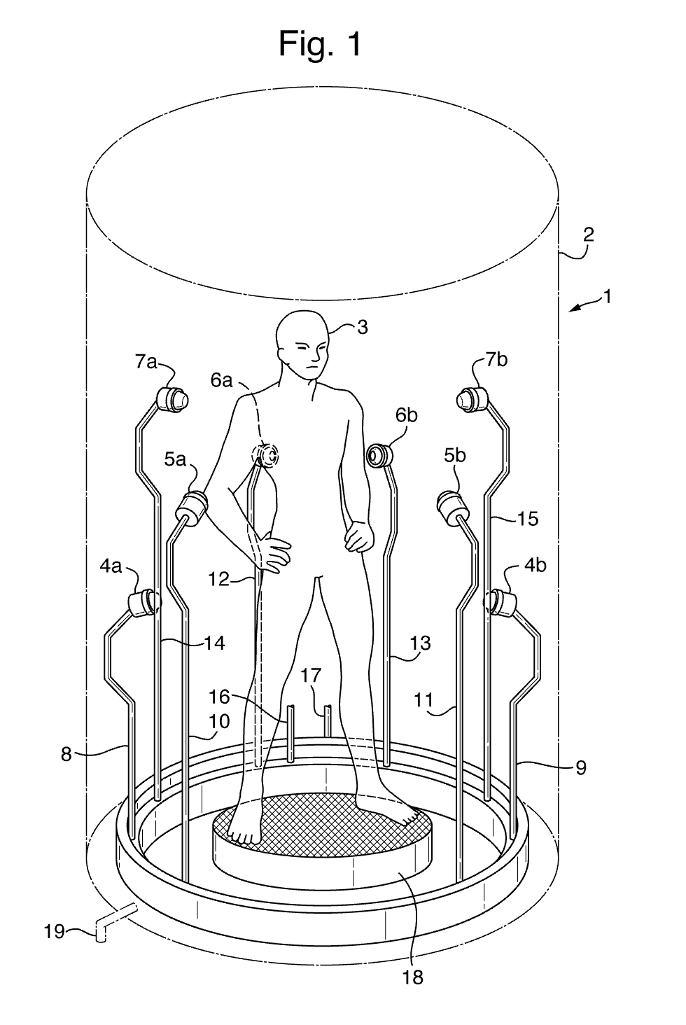

In FIG. 1 is seen an isometric view of a preferred embodiment of a shower apparatus. The shower apparatus 1 is broadly defined by the housing 2 which forms an enclosed space for a user 3 (the object in this embodiment). The housing 2 basically provides a frame to support and cover the shower heads. The apparatus has four sets of nozzles and each set has two shower heads disposed at substantially the same fixed height and substantially opposite to each other. Shower heads fixed at the given heights makes the apparatus less complex and more user-friendly.

The (sets of) shower heads are represented by the numerals 4a and 4b; 5a and 5b; 6a and 6b; 7a and 7b. Each set of shower heads is positioned at a height which is different from other sets. The set 4a and 4b is primarily meant to cleanse the lower body of the user 3. Set 5a and 5b are primarily meant for the hips and lower back. Shower heads 6a and 6b will cleanse the chest and the back and shower heads 7a and 7b are meant for the face and the head. Thus the spatial arrangement of shower heads provides complete body cleansing.

Each shower head is movable along the horizontal or vertical direction by upto 180°. This feature is provided by the use of gooseneck fittings. Therefore the user has no particular need to turn around while having the bath. This feature allows the user to further personalize the showers and to direct the mist to any particularly desired part or portion of the body. This feature also allows for further optimization of the number of shower heads and thereby enhances simplicity of the apparatus as well as the sustainability factor.

The plurality of shower heads positioned at different heights allows for personalization and targeted delivery of the mist to various, but particular parts of the body. The shower heads are arranged along the perimeter of a circle and are further arranged along a major arc of the circle of approximately 270°. This arrangement leaves some free space for easy entry and exit of the user. However, as the nozzles are movable along horizontal or vertical direction, the user will still be able to get 360° cleansing.

Each shower head is supported or carried by a pipe (reference numerals 8 to 15) and the length of the pipe provides the desired height. The pipe on which each shower head is supported is supplied with the gas and water through the respective tubing.

Each shower head has (features not seen in this view) a middle nozzle for spraying a gas and adjacent thereto are two nozzles for spraying water. All the nozzles are in the same plane (coplanar). In each set, the tip of each nozzle for spraying the liquid is at an acute angle of 45° with respect to the tip of the middle nozzle for spraying gas.

The apparatus also has an inlet 16 for water and another inlet 17 for the gas (air) which are individually connected to a source of water and air (not shown) A raised pedestal 18 is present for the user 3 to stand. The apparatus also has an outlet 19 for waste water.

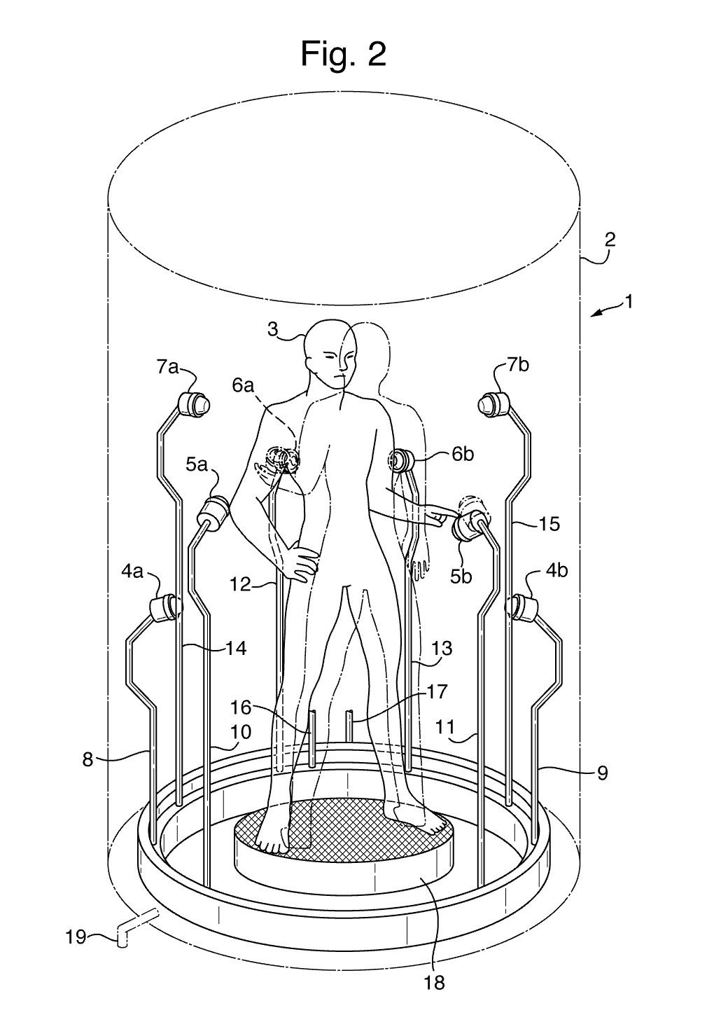

Referring now to FIG. 2 is seen an isometric view of the embodiment of FIG. 1 showing the user 3 (in silhouette/dotted lines) making adjustments to the shower heads to suit his needs. This feature provides for a personalised showering experience because the user can then target the mist to any desired part of his body.

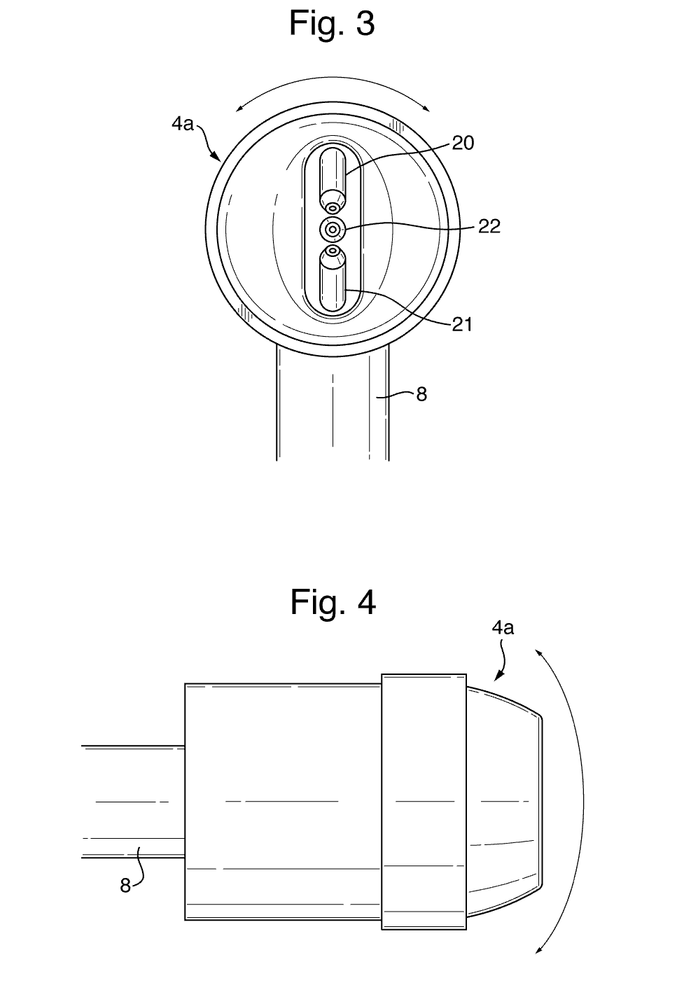

FIG. 3 is top (plan) view of a shower head. The shower head indicated herein by a representative numeral 4a has three nozzles. There is a pair of nozzles 20 and 21 meant for spraying water. The nozzle in the middle 22 is meant for spraying air. The tip of each nozzle 20 and 21 is at an angle of 45° with the tip of the nozzle 22.

FIG. 4 is side view of the shower head shown in FIG. 3 where a portion of the corresponding pipe 8 can also be seen.

In use the user first enters the apparatus and stands on the pedestal and switches the electronic controls on. In the first cycle, the shower heads spray mist of air and water on the user's body. As explained earlier, the user may make adjustments to the orientation of the shower heads if he wants the mist to be targeted to any particular part of his body. The first cycle lasts for about one minute in which the user's body is fully wetted. In the next cycle, the nozzles spray hot or cold air to dry the user's body.

The invention is not limited to the embodiment/s illustrated in the drawings. Accordingly it should be understood that where features mentioned in the appended claims are followed by reference signs, such signs are included solely for the purpose of enhancing the intelligibility of the claims and are in no way limiting on the scope of the claims.

1. A sustainable shower apparatus (1) comprising:
(i) a housing (2) for an object (3); and
(ii) plurality of shower heads (4a, 4b, 5a, 5b, 6a, 6b, 7a, 7b) positioned at different heights for spraying a mist comprising a pressurised gas and a liquid on said object;
wherein each shower head comprises at least one set of nozzles, where each set comprises:
(a) a nozzle (22) for spraying said gas; and
(b) adjacent thereto, at least one nozzle (20, 21) for spraying said liquid,
and wherein in each said set, the tip of each nozzle for spraying said liquid is at an acute angle to the tip of each adjacent nozzle for spraying gas.

2. A sustainable shower apparatus as claimed in claim 1 wherein position of each said shower head is fixed at given height.

3. A sustainable shower apparatus as claimed in claim 1 wherein said plurality of shower heads (4a, 4b, 5a, 5b, 6a, 6b, 7a, 7b) is made up of plurality of sets of shower heads (4a and 4b; 5a and 5b; 6a and 6b; 7a and 7b) where each set comprises at least two shower heads disposed at substantially the same height and substantially opposite to each other.

4. A sustainable shower apparatus as claimed in claim 3 comprising at least four sets of shower heads where each set comprises two shower heads.

5. A sustainable shower apparatus as claimed in claim 4 wherein first set of shower heads is positioned at height of 20 to 65 cm from base, second set of shower heads is position at height of 40 to 105 cm from base, third set of shower heads is positioned at height of 70 to 145 cm from base and fourth set of shower heads is positioned at height of 120 to 165 cm from base.

6. A sustainable shower apparatus as claimed in claim 1 wherein each said shower head is movable by at least 180° in vertical or horizontal direction or both.

7. A sustainable shower apparatus as claimed in claim 1 wherein said plurality of shower heads are arranged along perimeter of a circle of diameter 45 to 150 cm.

8. A sustainable shower apparatus as claimed in claim 7 wherein said plurality of shower heads are arranged along a major arc of the circle.

9. A sustainable shower apparatus as claimed in claim 8 wherein angle of said major arc is 245° to 320°.

10. A sustainable shower apparatus as claimed in claim 1 wherein each said shower head comprises one set of nozzles (20, 21, 22).

11. A sustainable shower apparatus as claimed in claim 10 wherein each said set comprises three nozzles comprising a middle nozzle for spraying said gas and two nozzles adjacent thereto, one each on either side thereof for spraying said liquid.

12. A sustainable shower apparatus as claimed in claim 11 wherein tip of said middle nozzle terminates a distance of upto 0.4 cm before or upto 1 cm ahead of tip of each nozzle for spraying said liquid.

13. A sustainable shower apparatus as claimed in claim 1 wherein said acute angle is 20° to 60°.

14. A sustainable shower apparatus as claimed in claim 1 wherein said liquid is water.

15. A sustainable shower apparatus as claimed in claim 1 wherein said gas is selected from air, oxygen or carbon dioxide.
